(19) United States
(12) Patent Application Publication
(10) Pub. No.: US 2022/0161466 A1
(43) Pub. Date: May 26, 2022

(54) METHOD FOR MANUFACTURING A HYDROPHOBIC ELEMENT

(71) Applicant: CELLOZ, Paris (FR)

(72) Inventor: Francois RUFFENACH, Levallois-Perret (FR)

(21) Appl. No.: 17/670,849

(22) Filed: Feb. 14, 2022

Related U.S. Application Data
(63) Continuation-in-part of application No. 16/484,522, filed on Aug. 8, 2019.

(30) Foreign Application Priority Data
Feb. 14, 2017 (FR) 1751177
Feb. 14, 2017 (FR) 1751187

(51) Int. Cl. B29C 43/56; B29C 43/04; B29C 71/02; B29C 71/04

(52) U.S. Cl. CPC B29C 43/56; B29C 43/04; B29C 71/02; B29K 2105/0026; B29C 2043/567; B29C 2043/563; B29C 71/04

(57) ABSTRACT

A method of manufacturing an embossed hydrophobic covering element for construction or decoration for protecting the surface from humidity or inclement weather. This method includes preparing a mixture of water and at least one organic material in a tank in which the organic material is insoluble in water, stirring the mixture so as to disperse the organic material in suspension in water, molding the prepared and stored mixture by immersing a forming mold under vacuum inside the tank in order to form a molded element, drying and densifying the molded element under vacuum so as to obtained a dried and densified element, and fully impregnating the dried and densified element in the binder so as to form the hydrophobic covering element. The binder is of an organic material. The organic material originates from a sustainably renewable resource.

### CROSS-REFERENCE TO RELATED APPLICATIONS

The present application is a continuation-in-part of U.S. patent application Ser. No. 16/484,522, filed on Aug. 8, 2019, and entitled “Method for Producing a Hydrophobic Element and Use Thereof”, presently pending.

### BACKGROUND OF THE INVENTION

### 1. Field of the Invention

The present invention relates to methods for manufacturing a hydrophobic covering element from bio-sourced materials. More particularly, the present invention relates to manufacturing a hydrophobic covering element from organic materials coming from resources that are sustainably renewable.

### 2. Description of Related Art Including Information Disclosed Under 37 CFR 1.97 and 37 CFR 1.98

In general, wall-finishing products, substantially consisting of organic material coming from resources that are sustainably renewable, or mainly wallpapers having a very fine layer of cellulose with or without a coating by a layer of often expanded synthetic materials. This very fine layer of cellulose has a total thickness of less than three millimeters. These products are presented in the form of a roll. There are applied onto a wall in successive lengths and pasted over the entire surface.

Alternatively, it is known to use covering elements having a relief These generally consist of agglomerated wood fibers of the MDF-type glued with a synthetic resin of polystyrene foam or of cork. Each of these materials has its own method. These elements are presented in the form of panels ranging from several millimeters to several centimeters thick.

None of the products of the prior art can preserve its initial shape over time and in humidity. None of these prior art allows the ability to ensure durable impermeability of the surface onto which they are applied.

With regard to the covering of surfaces in contact with the exterior environment, there are roof-covering elements made of cellulose impregnated with bitumen or thermosetting resins, such as plates, implemented while having respective longitudinal and transverse overlapping between them in order to ensure the impermeability of the roof These are included with accessories such as ridge tile, flashing or bargeboard. These accessories are connected to the elements and are capable of covering special points in the roofing. The bitumen and the thermosetting elements come from fossil resources. The use of these has a negative effect on the environment and on the human population. None of the current products allow one to substantially meet all of the required needs, namely ensuring impermeability without being harmful to the environment and to the human population.

It is an object of the present invention to overcome all or a portion of the disadvantages of the prior art mentioned above by a method of manufacturing a hydrophobic element, and a hydrophobic covering element, substantially coming from sustainably renewable resources.

It is another object of the present invention to provide a method for manufacturing a hydrophobic covering element and a hydrophobic covering element which is safe for humans and the environment.

It is another object the present invention to provide a method for manufacturing a hydrophobic covering element and a hydrophobic covering element that is economical.

It is still another object of the present invention to provide a method for manufacturing a hydrophobic covering element and a hydrophobic covering element that ensures the impermeability of the surface that it covers.

These and other objects and advantages of the present invention will become apparent from a reading of the attached specification and appended claims.

### BRIEF SUMMARY OF THE INVENTION

As used herein, the term “bio-sourced material” means of material coming from plant or animal biomass. The term “organic materials coming from sustainably renewable resources” means all of the chemical compounds formed by organic molecules found in the natural environment, of terrestrial or marine origin, and the stock of which can be replenished over a short period on the human timescale, by being renewed as fast as possible. The “covering element” can be used to cover at least a portion of an inner surface, such as a wall and/or a ceiling, where a surface is in contact with the exterior environment, such as roofing or cladding, in order to protect the surface from humidity or from inclement weather. The “covering element” can be used as a finishing element and can be used in the field of decoration.

According to the present invention, the covering and/or the finish of the surface is made from a covering element manufactured exclusively or almost exclusively from materials coming from the resources that are sustainably renewable. The covering element according to the present invention enhances the impermeability of the surfaces and allows the prevention of risk of fire, allows for insulation from noise, and allows from insulation from cold weather. For this purpose, the present invention is directed to a method for manufacturing a hydrophobic covering element in accordance with the following steps: (1) preparing a mixture of water and at least one organic material in a tank, the organic material being insoluble in water; (2) stirring the mixture so as to disperse the organic material in suspension in water, the organic material originating from a sustainably renewable resource; (3) molding the prepared and stirred mixture by immersing a forming mold under vacuum inside the tank in order to form a molded element; (4) drying and densifying the molded element under vacuum so as to obtain a dried and densified element; and (5) fully impregnating the dried and densified element in a binder so as to form the hydrophobic covering element, the binder being an organic material having a softening temperature between 50° C. and 80° C. The term “binder” means one or more organic materials coming from sustainably renewable resources capable of ensuring the cohesion of the fibers of the molded element and particularly effective in a human environment because of its rheological properties. The hydrophobic element obtained by this method thus comes entirely from sustainably renewable resources.

According to one feature, the organic material used in step (1) is non-soluble in water and can be dispersed with stirring in order to be in suspension in water. It ideally comprises molecules having a size greater than one μm. The organic material used in step (1) can be chosen from the group consisting of cellulose or hemicellulose extracted from plant fibers coming from wood, from cotton, from hemp, from jute, from flax, from bamboo, from abaca, from coconut, from sasal, from grass, from Gramineae, from algae, and from mushrooms. The organic material used in step (1) can also be from press cakes of oleaginous plants such as rapeseed, sunflowers, flax, soybeans, castor beans, peanuts, sesame, cotton, Crambe, hemp, Jatropha and/or neem. The organic material in step (1) can also come from waste from the agri-food industry or from agriculture such as cereal waste and, in particular, the stems and pods or husks of corn, of wheat, of bran, of rye, of rice, or waste from the fish industry. The organic material used in step (1) can also be materials that result from the grinding of stones or shells of fruits, such as olives, plums, walnuts, pistachios, peanuts, cocoa beans, and apple seeds. The organic material in step (1) can also be chips or sawdust of wood. Furthermore, the organic material used in step (1) can be a mixture of any of these organic elements. The organic materials used in step (1) are preferably a cellulose fiber, preferably coming from preferably recycled paper.

In order to advance further in terms of environmental safety and sustainable environment, the present invention endeavors to limit the use of fibers of cellulose coming directly from wood by the use of fibers coming from recycled paper. This provides a second life to these materials. Alternatively, the organic material used in step (1) is a mixture comprising at least one of the aforementioned organic materials and (a) vegetable proteins, such as albumin, globulin, prolamin, glutelin, casein, collagen or keratin; (b) plant fibers of any size and namely of a very small size of less than five μm, such as micro-fibrils of cellulose or nano-fibrils of cellulose or nanocrystalline cellulose; (c) bio-synthesized polymers such as lignin; (d) tannins; (e) polymer compounds chosen from the group formed by polysaccharides, polypeptides and galactoses, such as pectins, pectic substances, agar-agar, chitin or chitosan, gum arabic, or coming from the fermentation of sugars of plants, such as polylactic acid and its derivatives or the family of the polyhydroxyalkanoate (PHA, PHB, PHBV, etc.), or from a chemical reaction from a reactant such as the ester of cellulose; (f) cereal flours, beetroot pulp for flowers of protein crops; (g) keratin from sheep, goats, rabbits, llama, alpine pastures, guanaco, camel and/or yak wool, chickens, ducks, or goose feathers, or from mammal hoofs or horns; or (h) a mixture of these elements. The chitin should come from mushrooms, crustaceans or insects.

The pigments of mineral or organic origin from renewable materials that are added in step (1) are in proportions of between 0.1 and 10% of the total mass of dry organic materials in step (1). The quantity of water in step (1) is preferably greater than the quantity of organic material. The quantity of organic material is between 1 and 20%. All or a portion of these organic materials come from resources that are sustainably renewable that can undergo, or have previously undergone, a mechanical treatment such as refining, so as to allow an increase in the number of physical bonds between them and to reinforce the performance of the hydrophobic element.

The molded element at the output of step (b) contains between 20 and 35% organic materials and between 80 and 65% water. These compositions depend mainly on the type of organic materials that are used, on the initial concentration of organic material in the mixture prepared in step (1), on the duration of molding, on the temperature of the water, and on the molding method used. The step (2) of molding is preferably carried out by vacuum forming. The method of step (2) involves creating a depression inside a mold so as to create a forming mold. This is immersed in the mixture prepared in step (1) . The forming mold has orifices having a size of between 0.5 and 15 millimeters and, in particular, from 5 to 10 millimeters. The forming mold is lined with a fine wire mesh. The mesh has a size which is smaller than the orifices. As a result, the mixture prepared in step (1) is transferred and filtered on the surface of the metal sheet and the water is evacuated through the orifices of the mold. The forming mold is preferably metal or made of a synthetic material resistant to water and the temperatures of up to 75° C. The forming mold is maintained in the mixture prepared in step (1) for a peak between 0.5 seconds and 10 seconds relative to the initial concentration of organic material and the thickness and the desired weight for the element to be manufactured.

In one embodiment of the present invention, the step (2) of molding is carried out via a drum having four faces and having at least one forming mold on each of these faces. The molds are identical to each other. The drum rotates in accordance with a predetermined time sequence in such a way that each forming mold is immersed in the mixture prepared in step (1).

The step (3) of drying and densification is carried out by a pressing system having at least a pressing mold and a counter-mold pair. The term “densification” means the compacting of the molded element by pressing as the water is extracted. The step (3) of drying and densification can be carried out by a pressing system having at least one mold and at least one pressing counter-mold. The mold and the counter-mold pair are placed under a depression, while being heated, and the mold and counter-mold are pressed against one another. Each pressing mold and counter-mold comprises orifices of the size of between three and ten millimeters. These orifices are closed by nozzles with slots or holes in such a way that only water can be evacuated through them.

The element molded in step (2) is transferred into the pressing system. Each mold and counter-mold of the pressing system is placed under a depression, under vacuum, while being heated to a temperature preferably between 160 and 280° C. in order to evacuate the water contained in the molded element. The temperature is preferably between 200 ° C. and 280° C. The pressure applied between each mold and counter-mold during the pressing against one another is preferably between three and fifty bar in order to densify the molded element. This pressure is preferably between three and ten bar. The temperature and pressure are dependent on the quantity or on the thickness of the element molded in step (2) in order to avoid a deterioration of the organic material.

The temperature of each pressing mold and counter-mold is approximately 180° for thicknesses of a molded element of approximately one millimeter and is approximately 200° C. and preferably 220° for thicknesses of the molded element of approximately two millimeters. The temperature of each pressing mold and counter-mold is approximately 280° C. for thicknesses of the molded element of approximately three millimeters. If a polymerized organic material, such as polylactic acid is present in the element molded in step (2), the temperature of the molds and counter-molds must be adapted in such a way that it is greater by at least several degrees than the temperature of the melting point of the polymer.

According to one feature of the present invention, the pressing system has a plurality of pressing molds and counter-molds. The temperature of each pressing mold and counter-mold is identical in a preferred embodiment of the present invention. Alternatively, the temperature of each pressing mold and counter-mold is independently adjustable in such a way that the drying can follow a temperature profile according to the quantity of water remaining to be removed, thus preserving the organic material and allowing one to optimize the consumption of electricity. The pressure applied to each pressing mold and counter-mold can be independently adjustable. Each pressing mold and counter-mold is preferably formed of a metal material and is resistant to heat.

In one embodiment of the present invention, the pressing system has a plurality of pressing molds and/or a plurality of pressing counter-molds. These molds are disposed in a horizontally-aligned manner and the counter-molds are disposed thereabove also in a horizontally-aligned manner. This is called a “rectilinear system”. In this embodiment, the pressing molds are mobile vertically in the direction of the pressing counter-molds. The pressing counter-molds are mobile horizontally in order to move the molded element from one pressing mold to another. The pressing system, in particular, can comprise two pressing molds and three pressing counter-molds.

In accordance with another embodiment of the present invention, the pressing system can comprise a plurality of pressing molds and a plurality of pressing counter-molds. The pressing molds and the counter-molds are disposed in a circle and are capable of moving by rotation of the circle.

This is called a “carousel system”. In this embodiment, each counter-mold is located above and vertically in line with a mold in such a way so as to form mold and counter-mold pairs. The mold and counter-mold of the pair move together. The pressing system thus comprises a plurality of pressing mold and counter-mold pairs. The pairs are disposed in a circle and capable of moving by rotation of the circle.

Step (3) comprises a series of steps of drying and densification between a pressing mold and a counter-mold. In the carousel system, the element molded in step (2) is dried and densified in a single pressing mold and counter-mold pair over the duration of the rotation of the carousel. This carousel system allows one to limit the lost time during which no action of pressing and drying is carried out and which corresponds the time at which the vacuum and the pressure is stopped and at which the transfers are carried out. This loss of time of treatment of the material is advantageously reduced via the carousel system. With an equivalent number of mold and counter-molds, the circular transfer system allows an increase in productivity by addition to the “rectilinear system”. The element molded in step (2) is advantageously transferred into the pressing system via a counter-mold. This is called a “transfer counter-mold”.

In an embodiment of the present invention, the step (3) comprises an additional drying step in a hot air, infrared, microwave or high-frequency oven. This additional drying can be continuous. The element molded in step (2) is transported on a conveyor entering and exiting on either side of the oven. The additional drying allows one to improve the productivity by maximizing the production volume of a manufacturing unit. The drying temperature is adjustable in such a way that the drying can be adapted to the quantity of water to be extracted according to parameters measured in line and to the weight of the element to be obtained. This additional drying is advantageously carried out before the step (c) of drying the elements molded in step (2) comprising between 80 and 50% water in order to evacuate a certain quantity of water and raise the temperature of the water remaining in the molded element. Alternatively, this additional drying is carried out after a first step of drying and densification of the molded element by first mold and counter-mold pair. Step (3) also can include a final step of drying of the element that is carried out in a hot air, infrared, microwave or high-frequency oven. Alternatively, the final step of drying of the element is carried out by drying between a mold and a counter-mold with a previous step of humidification by spraying of water onto the two faces of the element. This final drying step allows the quantity of organic matter to be between 75% and 100%.

Step (3) is thus carried out via a system of pressing and heating molds and counter-molds so as to ensure the sequential rectilinear or circular transfer of the element with adjustable pressures and temperatures or by a combination of the system with one or more additional dryings using hot air, infrared, microwaves, or high-frequency.

The full impregnation step (4) involves immersing the dried and densified element obtained in step (3) in the binder. The binder is composed of organic materials coming from resources that are sustainably renewable. The binder is an organic material having a softening temperature between 50° C. and 80° C. The viscosity of the binder is reduced in such a way that it can correctly impregnate the element obtained in step (3). The viscosity of the binder is less than 500 MPa at a temperature of 160° C. The softening temperature of the binder, as defined by French standard NF EN 1427, is between 50° C. and 80° C.

The organic material of the binder can be selected from residues coming from processes of the decomposition of wood. In particular, these can be the conifers by the Kraft process, such as crude tall-oil, tall-oil pitch, the fatty acids of tall-oil and their derivatives, the resins of tall-oil and their derivatives, and the resins of rosin and their derivatives. The organic material in the binder can also be lipids, such as unsaturated fatty acids (along with vegetable or animal oils). These lipids can also be an oil of castor beans, of tong, of flax, and of castor oil. The organic material of the binder can also be polymer compounds chosen from among polysaccharides, polypeptides and galactoses, such as pectins, pectic substances, agar-agar, chitin and/or chitosan, gum arabic, tannins, or coming from the fermentation of sugars of plants, such as polylactic acid and its derivatives of the family of polyhydroxyalkanoate (PHA, PHB, PHBV, etc.), or from a chemical reaction with a reactant, such as the ester of cellulose. The organic material can also come from a mixture of these organic materials. The chitin can come from mushrooms, crustaceans or insects.

Alternatively, the organic material of the binder is a mixture having at least one of the organic materials mentioned above (identified as the “main organic material”) and of other more organic materials coming from resources that are sustainably renewable. These “secondary organic materials” can include: (1) resins of rosin and their derivatives, terpene phenolic resins, and resins of fatty acids; (2) resins of tall-oil and their derivatives; (3) bio-synthesized polymers from renewable resources such as lignins, PLA polylactic acid and its derivatives, or the family of polyhydroxyalkanoate (PHA, PHB, PHBV, etc.); (4) stand oils of vegetable oil; (5) phospholipids such as lecithin; (6) natural waxes; or (7) gum resins. The binder comprises between 20 and 100% and preferably between 50 and 100% main organic material by mass.

The binder can contain an antioxidant agent and/or a drying agent between 0.1% and 5% of the binder by mass. The binder has an organic material coming from resources that are sustainably renewable in liquid form between 20 and 150° C. or a mixture of organic materials coming from resources that are sustainably renewal in which the mixture is in a liquid form between 20 and 150° C. In general, the composition of the binder depends on the type of exposure to which the hydrophobic element will be subjected in order for the performance of the latter to be maintained. This is, for example, in an environment such as cold temperature environments, hot temperature environments, or tropical environments. Tall-oil and its derivatives are residues from the treatment of the conifers during manufacture of papers according to the Kraft process. The derivatives of tall-oil are non-volatile residues (called “tall-oil pitch”) obtained after saponification and acidification of the tall oil. The binder is a plant binder composed of derivatives of tall-oil, such as tall-oil pitch. The lignins come from paper processes using sulfate (Kraft lignin) or using sulphite (lignosulphonate).

The rosin resin and the terpenes obtained from plant resin extracted from the resin-producing trees by tapping (incision under the bark of the tree allowing the resin to flow) or from the residues coming from the manufacturer of papers according to the Kraft process. In a preferred embodiment, the resin comprises 70% tall-oil pitch by mass, 15% terpene phenolic resin and 10% additives, such as plant wax or linseed oil. In alternative embodiment, the binder comprises 49% terpene phenolic resin by mass, 49% low-viscosity esterified rosin resin and 2% antioxidant and tannins. The binder is previously prepared by batch or continuously prepared under an inert atmosphere. The preparation of the binder involves heating the main organic material to a temperature of at least 150° and continuously mixing it with the secondary organic material heated to 150° C. in a static mixer. One alternative involves mixing the main organic material, previously heated to 150° C., with the secondary organic material in a screw or paddle mixer heated to 150° C. The binder thus obtained supplies the impregnation tank in a closed circuit.

The element of obtained in step (3) has a total quantity of materials of at least 97% in order to not cause an evaporation of water that is too great during its impregnation. The duration (called “duration of impregnation”) is between five and thirty minutes. One alternative involves creating a vacuum in an impregnation tank containing the elements before immersing them in the binder then creating an overpressure during the impregnation in such a way as to accelerate the step of impregnation. Then, the binder is progressively evacuated from the tank by a pumping system before removing the impregnated element therefrom. The term “progressively” means a regular linear speed of draining the impregnation tank of less than one meter per minute, or preferably of less than thirty centimeters per minute. The speed of the draining of this is the speed at which the element crosses the free surface of the binder. Each element is stored upright in the impregnation tank in such a way as to present its thickness to the free surface of the binder. The free surface of the binder follows the length of the element during the draining of the impregnation tank.

The manufacturing method further includes step (5) involving coating the hydrophobic element obtained in step (4) with a coating. Step (5) is a finishing step. The coating is one or more layers of a finishing material, such as a paint, chosen from the group of materials containing mineral pigments and mineral fillers, bio-sourced organic pigments coming from resources that are sustainably renewable materials containing plant resins coming from biomass, material and materials containing synthetic resins. The coating comprises mineral pigments, organic pigments coming from renewable materials and mineral fillers. The coating can comprise organic resins coming from resources that are sustainably renewable. In particular, the coating can comprise synthetic resins, such as acrylic resins.

A fireproofing and/or hydrophobic treatment is carried out in step (1) and/or during step (4) and/or during step (5). This fireproofing and/or hydrophobic treatment can be carried out in step (1) and/or during the step of impregnation and/or during the finishing step (5). The materials capable of conferring fireproofing and/or hydrophobic properties are added during these steps.

The present invention further relates to a hydrophobic element for covering at least a portion of a surface, such as a wall to and/or a ceiling and/or a surface in contact with the external environment. This element has a developable or non-developable shape and has a back in contact with the surface of a visible front. In particular, this hydrophobic element comprises more than 90% organic material coming from sustainably renewable resources. The term “developable shape” means a shape that can be applied onto a plane. Thus, a “developable shape” can be deployed along a generatrix having the same plane tangent to the latter. In contrast, a “developed shape” is one that is all already deployed.

The hydrophobic covering element has a low impact on the environment. It has, because of its makeup, a low weight that facilitates its implementation. It has a resistance to water and a resistance to thermal and mechanical stresses. As such, it is appropriate as an element for covering a roof. The term “hydrophobic element” means a hydrophobic covering element. The “hydrophobic element” can take on a multitude of developable or non-developable shapes in order to adapt to the local architecture or to create innovative shapes. It is important to note that a developable or non-developable shape is not related to a particular use or to a particular context of use of this element.

According to various embodiments of the present invention, the visible front is capable of having a relief with a decorative appearance. The visible front of the hydrophobic element can have varied appearances constituting decorative objects and shapes, such as reliefs with multiple shapes capable of covering at least a portion of the surface of a wall, of a ceiling, or of a roof. The hydrophobic element can be adapted for resisting climatic stresses, such as the sun, wind, rain, snow, etc. This aspect is very advantageous for the covering of the surface in contact with the exterior environment, such as roofing. The hydrophobic element will not contain any bitumen or equivalent product. The hydrophobic element is obtained according to the method described above.

The level of binder impregnation is between 30% and 60% according to the thickness and density of the element. The level of impregnation of the binder is defined as being the quantity of the binder divided by the quantity of the dried and densified element obtained in step (3) plus the quantity of binder. The level of materials, synthetic or coming from resources that are sustainably renewable, deposited as a coating during step (5) represents less than 10% of the total quantity of materials used to create the hydrophobic element.

The present invention relates to the use of a hydrophobic covering element for the covering of at least a portion of a surface in contact with the exterior environment, such as roofing or cladding. The present invention relates to the use of a hydrophobic covering element that is a decorative object chosen, in particular, from the group comprising friezes, complaints, moldings, and decorative panels. The hydrophobic element can also be used to camouflage cables or devices or security alarms, such as sensors used in the case of break-ins or fires. For this purpose, the hydrophobic element can comprise housings on both the front and the back. The hydrophobic element can thus be used as an element for covering a roofing, a wall, or a portico. For example, the hydrophobic element is placed on a frame with the slope of at least 12° by spacing patterns of 480 millimeters in such a way that each hydrophobic element is carried by 3 battens (one at each end and one at the center of the hydrophobic element). The fastening of the hydrophobic element is carried out with nails (such as nails with plastic heads) or screws (such as screws with a plastic head). These can be nails or screws with overmolded heads. A plurality of hydrophobic elements can be positioned on a frame in such a way that they ensure the impermeability of the roofing. Alternatively, there can be an alteration between an entire hydrophobic element and a half of a hydrophobic element in such a way that they are placed in staggered rows. The hydrophobic element of the present invention can take on various shapes having a relief height ranging from several millimeters up to twenty centimeters and a thickness that can be varied according to the exposure to a risk of stress. The thickness can vary between one-half millimeters to six millimeters. The height of the relief can be between one millimeter and two-hundred millimeters.

For example, a hydrophobic element intended to be applied onto a ceiling will have a thickness of one millimeter, whereas a hydrophobic element applied to a wall and exposed to persons passing by and to occasional impacts will have a greater thickness of, for example, three millimeters. The dimensions of the hydrophobic element depend on its use. In the case of a frieze or of a molding, it can have a circular shape with a diameter ranging from several millimeters or a rectilinear shape with a length of several millimeters and a width of several millimeters. In the case of a frieze or of a decorative panel, it can have various shapes, but preferably rectangular. In this case, it can cover the totality of a wall with each element being placed edge-to-edge. The hydrophobic element can be applied onto the surface with a double-sided adhesive or with a coating gun on the back of the element or on the surface to be covered.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a schematic front view illustrating steps (1) and (2) of the method of the present invention.

FIG. 2 is a schematic front view of a forming mold used in step (2) of the method of the present invention.

FIGS. 3 and 4 are diagrams illustrating alternatives of step (2) of the method of the present invention.

FIG. 5 is a diagram illustrating step (3) of the method of the present invention.

FIG. 6a is a schematic front view of a pressing mold used during step (3) of the method of the present invention.

FIG. 6b is a schematic top view of the mold of FIG. 6a.

FIG. 7 is a schematic perspective top view of a hydrophobic element for a roof covering.

FIG. 8 is a schematic front view of an alternative to that shown in FIG. 7.

FIG. 9 is an example of a hydrophobic element for covering a wall viewed from above.

FIG. 10 shows a wall covered by hydrophobic elements of FIG. 9.

### DETAILED DESCRIPTION OF THE INVENTION

As used hereinafter, the terms “horizontal”, “vertical”, “transverse” and “longitudinal” should be understood as qualifying elements resting in a fixed manner in parallel to the ground. The method of the present invention is the following steps: (1) preparation of a mixture of water and of organic material coming from resources that are sustainably renewable; (2) molding the mixture prepared in step (1) in order to obtain a molded element; (3) drying and densifying the molded element obtained in step (2) in order to obtain a dried and densified element; and (4) fully impregnating the dried and densified element obtained in step (3) in a binder composed of organic materials coming from resources that are sustainably renewable. In particular, this step (1) involves preparing a mixture of water and at least one organic material in a tank in which the one organic material is insoluble in water. This mixture is stirred so as to disperse the organic material in suspension in water. The organic material originates from the sustainably renewable resource. The step (2) of molding the prepared and stirred mixture occurs by immersing a forming mold under vacuum inside the tank in order to form a molded element. The step (3) of drying and densifying involves drying and densifying in the molded element under vacuum so obtained a dried and densified element. The step (4) of fully impregnating involves fully impregnating the dried and densified element of the binder so as to form the hydrophobic covering element. The binder is an organic material having a softening temperature of between 50° and 80° C. Importantly, the step of molding includes applying a molding cloth onto the portion of the mixture for a time of between one-half second and ten seconds. This increases the effect of suction in the mold and obtains the molded element. The cloth carries out a horizontal translation in the direction of the forming mold. This method allows one to obtain a hydrophobic element.

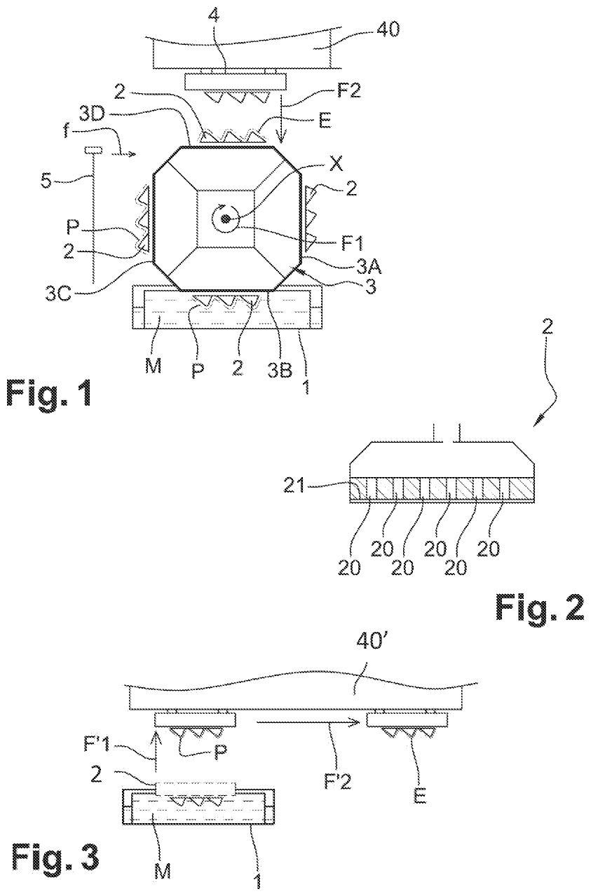

In particular, the steps (1) and (2) of preparing a mixture M of water and of cellulose fibers and of molding this mixture are illustrated in FIG. 1. The mixture M of water and of 1 to 20% cellulose fibers is prepared in a tank 1 at a temperature between 10° C. and 75° C. and preferably between 35° C. and 45° C. The forming mold 2 is shown in more detail in FIG. 2. This forming mold 2 is immersed, under vacuum, in the tank 1 containing the mixture M so that a portion P of the mixture M is transferred onto the forming mold 2. The forming mold 2 is disposed on a drum or shaft 3 having four faces 3A, 3B, 3C, 3D in which each comprises the forming mold 2. The drum 3 successively carries out rotations of 90° about a central axis X in such a way that each forming mold 2 of each face 3A, 3B, 3C and 3D is immersed in the tank 1 containing the mixture M. The speed of rotation of the drum 3 is approximately 1.5 to 30 r.p.m. The portion P of the mixture M transferred onto the surface of each forming mold 2 is thus molded under vacuum in such a way as to obtain a molded element E. The molded element E is then transferred onto the surface of a transfer counter-mold 4, under vacuum, and disposed on a plate 40 above the drum 30. The step of transfer of the molded element E is possible via the creation of an overpressure (stoppage of the vacuum) in the forming mold 2 comprising the molded element E and of a depression (i.e. vacuum) in the transfer counter-mold 4.

More particularly, the molding step involves: (a) immersing the face 3A of the drum 3 comprising the forming mold 2 in the tank 1 comprising the mixture M in such a way as to transfer a portion P of the mixture M onto the surface of the forming mold 2 via a first rotation of the drum 3 by 90° in the clockwise direction according to the arrow F1; (b) after a time of between 0.5 and 10 seconds, carrying out a second rotation of the drum 3 by 90° in the clockwise direction according to the arrow F1 so that the face 3A is located perpendicularly to the tank exterior of the tank; (c) applying a molding cloth 5 onto the portion P of the mixture M for a time of between 0.5 and 10 seconds in order to increase the effect of suction in the forming mold 2 and to obtain the molded element E. The cloth carries out a movement of horizontal translation in the direction of the forming mold 2 in the direction of the arrow f; (d) carrying out a third rotation of the drum 3 by 90° in the clockwise direction according to the arrow F1 in such a way that the face 3A and the molded element E are located in parallel to the transfer counter-mold 4; (e) lowering the transfer counter-mold 4 onto the molded element E according to arrow F2; and (f) creating a depression in the mold 2 and raising the transfer counter-mold 4 so that the molded element 3 is disposed on the surface of the counter-mold. According to this method, the forming mold 2 of the face 3A is empty.

A fourth rotation of the drum 3 by 90° in the clockwise direction allows the positioning of the face 3A perpendicularly to the tank 1. Then, the steps described above are repeated in such a way as to mold a plurality of molded elements E. The vacuum created inside the forming mold 2 maintains the portion P of the mixture M on the surface of the forming mold 2. When the transfer counter-mold 4 is lowered against the forming mold 2, the molded element E is smooth and densified.

FIG. 2 shows that each forming mold 2 comprises orifices 20 that are lined with a bottom mesh 21. The orifices 20 have a have a thickness of between three and ten millimeters. The bottom mesh 21 is a mesh having a size smaller than the orifices 20.

In a second embodiment, illustrated in FIG. 3, a forming mold 2 is immersed, under vacuum, in the tank 1 having the mixture M. The forming mold 2 having a portion P of the mixture M carries out a movement of vertical translation according to the arrow F′1 in order to remove the forming mold 2 from the tank 1. Then, the forming mold 2 carries out a movement of horizontal translation in the direction of a belt contact conveyor (not shown) according to arrow F′2 until a molded element E is obtained. The molded element E is then deposited on the belt conveyor (not shown) after creation of an overpressure (stoppage of the vacuum) in the forming mold 2. The forming mold 2 is suspended from a plate 40′ by elements that allow its vertical and horizontal movement. The belt conveyor allows movement of the molded element E in the direction of a pressing system 6 as shown in FIG. 5.

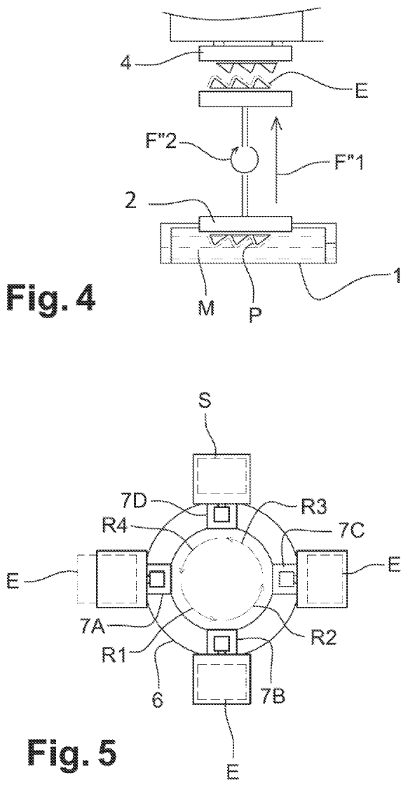

A third embodiment is illustrated in FIG. 4 in which the forming mold 2 is immersed, under vacuum, in the tank 1 having the mixture M. The forming mold 2 carries out a movement of vertical translation according to the arrow F″1 and a movement of rotation of 180° according to the arrow F″2 in such a way as to present the molded element E opposite a transfer counter-mold 4 as described in relation to FIG. 1. The transfer of the molded element E from the forming mold 2 to the transfer counter-mold 4 takes place in the same way as above in the accordance with the first embodiment.

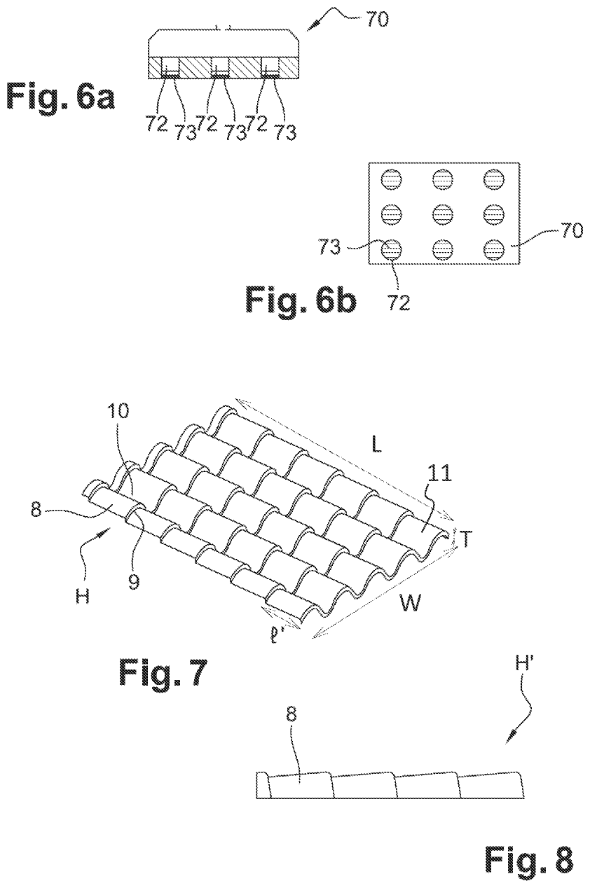

FIG. 5 shows that the molded element E is transferred to a carousel pressing system 6. The carousel pressing system 6 comprises four pressing molds 70 (shown in FIGS. 6a and 6b) and counter-mold pairs 7A, 7B, 7C and 7D. More precisely, the molded element E is transferred into a first pressing mold and a counter-mold pair 7A in which the mold and counter-mold are pressed against one another, under vacuum. The mold and counter-mold are heated to a temperature of between 160 to 280° C. The carousel pressing system 6 then carries out a succession of rotation by 90° in the counter-clockwise direction in accordance with arrows R1, R2, R3 and R4, in such a way that each pair 7A, 7B, 7C and 7D can receive a molded element E. When the pair 7A has carried out three rotations of 90°, a dried and densified element S is obtained. The mold and counter-mold of the pair 7A move apart from one another and the dried and densified element S is transferred to the step of impregnation.

As shown in FIGS. 6a and 6b, each pressing mold 70 has orifices 72 having a size of preferably between three and ten millimeters. These orifices 72 are closed by nozzle 73 with slots or holes. Each counter-mold also has orifices and nozzles.

In the context of construction, the present invention is more particularly described with regard to a hydrophobic covering element for roofing or a hydrophobic element for covering roofing without being limited such a use. The term “covering element for roofing” means an element capable of covering at least a portion of the surface of a roof. The term “element for covering roofing” designates both the main covering elements for roofing, such as the plates or tiles, and the accessories, such as ridge tile, flashing or bargeboard.

FIG. 7 shows an example of a hydrophobic element H obtained after the step of impregnating. The hydrophobic element H is intended for use in roofing. It is in the form of a corrugated plate with a visible front 11 and an opposite back. The plate is substantially parallelepipedic with a length “L” equal to 1020 millimeters, a width “W” equal to 665 millimeters, a thickness “T” equal to 2.5 millimeters and a non-developable shape. Along the length “L”, there are six rows of five tiles 8. The tiles 8 are parallel to each other. The longitudinal direction of a tile 8 is identical to the longitudinal direction of the hydrophobic element H. Each row of tile 8 is separated by an offset 9. The tiles 8 of the same row are connected to each other by a groove 10. Each tile 8 has a length “L” of 160 millimeters.

FIG. 8 shows an alternative H′ of the hydrophobic element H of FIG. 7. In this alternative embodiment, the hydrophobic element H′ is intended be used as a ridge tile or ridge accessory. The hydrophobic element H′ has four tiles 8 longitudinally fitted together in the longitudinal direction.

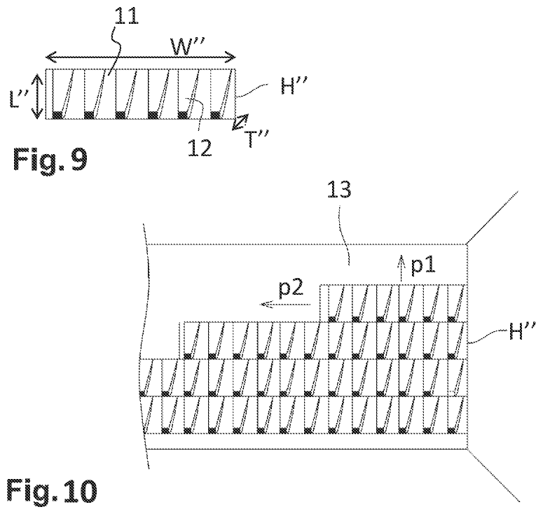

FIG. 9 shows another example of a hydrophobic element H″ with the width “W″”, length “L″” and thickness “T″” viewed from above. The hydrophobic element H″ comprises a visible front 11 having a relief 12 with a spindle shape repeated six times.

FIG. 10 shows the placement of hydrophobic elements H″ on a surface 13 formed by a wall. The hydrophobic elements H″ are those shown in FIG. 9. A plurality of hydrophobic elements H″ are already placed on the wall 13 by using glue. The arrows p1 and p2 in FIG. 10 indicate the direction of placement in order to finish completely covering the wall 13.

The foregoing disclosure and description of the invention is illustrative and explanatory thereof. Various changes in the details of the steps of the present method can be made in accordance with the present claims without departing from the true spirit of the invention. The present invention should only be limited by the following claims and their legal equivalents.

I claim:

1. A method of manufacturing an embossed hydrophobic covering element for construction or decoration for protecting a support surface from humidity or inclement weather, the method comprising:
preparing a mixture of water and at least one organic material in a tank, the at least one organic material being insoluble in water;
stirring the mixture so as to disperse the at least one organic material in suspension in water, the at least one organic material originating from a sustainably renewable resource;
molding the prepared and stirred mixture by immersing a forming mold under vacuum inside the tank in order to form a molded element;
drying and densifying the molded element under vacuum so as to obtain a dried and densified element; and
fully impregnating the dried and densified element in a binder so as to form the hydrophobic covering element, the binder being an organic material having a softening temperature of between 50° C. and 80° C.

2. The method of claim 1, wherein the step of drying and densifying is carried out in a pressing system, the pressing system having at least one pressing mold and counter-mold pair.

3. The method of claim 2, wherein the at least one pressing mold and counter-mold pair is placed under a depression while being heated and are pressed against one another.

4. The method of claim 2, wherein the at least one pressing mold and counter-mold comprises a plurality of pressing mold and counter-mold pairs, the plurality of pressing mold and counter-mold pairs being disposed in a circle and moved by rotation of the circle.

5. The method of claim 1, wherein the step of drying and densifying comprising:
additional drying in a hot air oven.

6. The method of claim 1, wherein the step of drying and densifying comprising:
additional drying in an infrared oven.

7. The method of claim 1, wherein the step of drying and densifying comprising:
additional drying in a microwave oven.

8. The method of claim 1, wherein the step of drying and densifying comprising:
additional drying in a high-frequency oven.

9. The method of claim 1, wherein the organic material of the binder is in liquid form at between 20° C. and 150° C.

10. The method of claim 1, wherein the binder is from a mixture of organic materials, the mixture being in liquid form at between 20° C. and 150° C.

11. The method of claim 1, wherein the organic material of the binder is a derivative of tall-oil.

12. The method of claim 1, further comprising:
coating the hydrophobic covering element with a coating.

13. The method of claim 12, wherein the coating is at least one layer of a finishing material, the finishing material selected from the group consisting of mineral pigments, mineral fillers, biosourced organic pigments from sustainably renewable resources, materials containing plant resins from biomass, and materials containing synthetic resins.

14. The method of claim 12, further comprising:
fireproofing the hydrophobic covering element.

15. The method of claim 12, further comprising:
hydrophobically treating the coated hydrophobic covering element.

16. The method of claim 1, further comprising:
partially covering a roof with the hydrophobic covering element.

17. The method of claim 1, further comprising:
partially covering a cladding with the hydrophobic covering element.

18. The method of claim 1, further comprising:
forming the hydrophobic covering element into a decorative object, the decorative object selected from the group consisting of a frieze, a molding and a decorative panel.

19. The method of claim 1, the step of molding comprising:
applying a molding cloth onto the portion of the mixture for a time of between 0.5 seconds and 10 seconds, the molding cloth carrying out a horizontal translation in a direction of the forming mold.

20. A method of manufacturing an embossed hydrophobic covering element for construction or decoration for protecting a support surface from humidity or inclement weather, the method comprising:
preparing a mixture of water and at least one organic material in a tank, the at least one organic material being insoluble in water;
stirring the mixture so as to disperse the at least one organic material in suspension in water, the at least one organic material originating from a sustainably renewable resource;
molding the prepared and stirred mixture by immersing a forming mold under vacuum inside the tank in order to form a molded element, the step of molding comprising:
applying a molding cloth onto the portion of the mixture for a time of between 0.5 seconds and 10 seconds, the molding cloth carrying out a horizontal translation in a direction of the forming mold;
drying and densifying the molded element under vacuum so as to obtain a dried and densified element; and
fully impregnating the dried and densified element in a binder so as to form the hydrophobic covering element, the binder being an organic material having a softening temperature of between 50° C. and 80° C.
